(19) United States
(12) Patent Application Publication
(10) Pub. No.: US 2005/0082011 A1
(43) Pub. Date: Apr. 21, 2005

(54) Structure for coupling a coating film transfer tool with stationery

(75) Inventors: Kazuya Watanabe, Osaka-shi (JP); Keiichiro Minegishi, Osaka-shi (JP); Masahiko Ono, Osaka-shi (JP); Keisuke Fujii, Osaka-shi (JP)

Correspondence Address: HOWSON AND HOWSON;ONE SPRING HOUSE CORPORATION CENTER, BOX 457, 321 NORRISTOWN ROAD, SPRING HOUSE, PA, 19477, US

(73) Assignee: c/o Fujicopian Co., Ltd., Osaka-shi (JP)

(21) Appl. No.: 10/928,622

(22) Filed: Aug. 27, 2004

(30) Foreign Application Priority Data
Aug. 29, 2003 (JP) 306754/2003

(51) Int. Cl. B44C 1/00

(52) U.S. Cl. 156/540; 156/577

(57) ABSTRACT

A structure for coupling a coating film transfer tool to an article of stationery comprises a shaft-shaped member integrally formed on an end of the coating film transfer tool, and a bore-shaped member integrally formed on an end of the article of stationery. A projection is formed on the shaft-shaped member, an L-shaped cut-out, into which the projection can be inserted, is provided on the side wall of the bore-shaped member, and a stop for retaining the projection is provided adjacent the innermost end of the cut-out section. The coating film transfer tool and the article of stationery are connected by inserting the projection into the cut-out section and rotating the transfer tool when the projection reaches the end of the entry leg of the L-shaped cut-out, until the projection passes over the stop.

### FIELD OF THE INVENTION

This invention relates to a structure for coupling a coating film transfer tool with an article of stationery such as a writing implement.

### BACKGROUND OF THE INVENTION

Coating film transfer tools are used for transferring a film onto a receiving surface. Such tools may be used for the transfer of a correction film, an adhesive film, a decorative film, etc. It is common for a coating film transfer tool to be removably integrated with a ball-point pen or other article of stationery, so that the coating film transfer tool can be replaced.

For example, FIG. 9 depicts a combination writing instrument and coating film transfer tool disclosed in unexamined Japanese Patent Publication No. 25056/1998. The device comprises an elongated case 61, divided into two parts at an intermediate location along the longitudinal direction. A transfer head 64 is provided for pressing a transfer tape T against a receiving surface (not shown) so that a material such as an adhesive or a correcting coating, laminated onto the tape, can be transferred to the receiving surface.

The case 61 comprises case elements 61A and 61B, each case element comprising two plate-shaped members which are fitted to each other. The case elements 61A and 61B are removably coupled by a joint member 66, having oppositely facing recesses which receive end projections on the respective case elements.

The case element 61A functions as a coating film transfer tool, and the case element 61B, being equipped with a pen point 68, functions as a writing instrument. A removable protective cap 69 covers the pen point 68.

FIG. 10 shows another combination writing instrument and coating film transfer tool 70, disclosed in unexamined Japanese Patent Publication No. 181288/1998. The device comprises a pen section 72 and a coating film transfer tool 73 on opposite sides of a tubular coupling 71. A projection on the coating film transfer tool 73 fits removably into a hole formed in the coupling 71.

When a used transfer tool is removed in the process of replacement, the joint member can accidentally come off the article of stationery together with the transfer tool. In such a case, it is difficult for users to couple a new coating film transfer tool with the article of stationery. In addition, the device requires another component in addition to the transfer tool and the article of stationery.

To address the above-mentioned problems, a combined coating film transfer tool and writing implement 80, as shown in FIG. 11, has been provided, in which the transfer tool 82 and the writing implement 84 are directly and removably coupled. The coating film transfer tool 82 is provided with a shaft-shaped member 86 which is integrally formed on the end of the transfer tool, and a bore-shaped member 88 is integrally formed on an end of the writing implement. These members 86 and 88 can comprise screw threads as shown for example in FIG. 12 and described in unexamined Japanese Patent Publication No. 511265/2003. Alternatively, the members can comprise projections and recesses as shown in FIG. 13. In the case where the members have projections and recesses, coupling is achieved by fitting the projections and the recesses of the members 86 and 88 into each other.

The article of stationery 84 and the coating film transfer tool 82 can be integrated simply by fitting the member 86 on the coating film transfer tool 82 into the member 88 on the article of stationery 84, without a separate, intermediate, joint member. A used coating film transfer tool can be removed from the article of stationery and replaced by a new coating film transfer tool by securely mounting the new coating film transfer tool directly onto the article of stationery. However, when the members 86 and 88 comprise screw threads as shown in FIG. 9, it is necessary to rotate one element relative to the other in order to engage or disengage the threads. In addition, the structure of the mold for forming the product is complicated, and the production of the product is time-consuming and labor-intensive.

On the other hand, when the members 86 and 88 comprise the projections and recesses as shown in FIG. 13, the insertion force encountered during assembly, and the ability of the joint to hold the two elements together, tend to vary. The variation in the insertion force and in the holding capability of the joint is due to changes in the dimensions of the members 86 and 88. Therefore, close control of dimensions is required, and accurate processing is necessary, causing production to be time-consuming and labor-intensive.

In view of the above-mentioned problems, the object of this invention is to provide a structure for coupling a coating film transfer tool with an article of stationery, wherein connection and removal can be achieved easily; fluctuations of load, both at the time of insertion and after integration, is small even when the dimensions of the members vary; and production can be achieved in short period of time and at low cost.

### SUMMARY OF THE INVENTION

In accordance with the invention, a combination coating film transfer tool and article of stationery comprises a first member formed as an integral part on one end of the coating film transfer tool and a second member formed as an integral part on one end of the article of stationery. One of said members is in the shape of a shaft and the other member is in the shape of a bore. The member in the shape of a shaft is received in the member in the shape of a bore.

In a first embodiment, a projection is formed on the shaft-shaped member, an L-shaped cut-out, into which the projection can be inserted, is provided in said bore-shaped member, and a stop for retaining the projection is provided adjacent the innermost end of the cut-out.

In a second embodiment, a partition divides the bore of the bore-shaped member into two parts. The partition has an insertion hole, and the shaft-shaped member has an extension corresponding in shape to the insertion hole and insertable through the insertion hole. Either the partition or the extension has a projection, and the other has a recess capable of receiving the projection. When the extension is inserted through the insertion hole in the partition and rotated, the projection may be inserted into the recess, thereby removably securing the coating film transfer tool to the article of stationery.

In a third embodiment, the shaft-shaped member has an extension which has a uniform cross-sectional shape. The bore-shaped member has a cut-out section in its sidewall, corresponding to the shape of the extension. A recess is provided on one of the extension and the cut-out section and a projection is provided on the other of the cut-out section and the extension. The shaft-shaped member is secured to the bore-shaped member by insertion of the extension through the cut-out section, and fitting the projection into the recess.

According to the invention, since coupling of the transfer tool and article of stationery can be achieved by utilizing the shapes of members, fluctuations in the load at the time of insertion, and the force required to release the connected members, can be kept small, and are not greatly affected by dimensional changes in the members. Close control of the dimensions of the members is not required, and consequently, a combination coating film transfer tool and article of stationery can be produced quickly and at a lower cost. Moreover, since connection and disconnection of the members is achieved by without the use of a screw mechanism, attachment and removal of the transfer tool from the article of stationery can be achieved easily.

### BRIEF DESCRIPTION OF THE DRAWINGS

FIG. 1 is a perspective view showing the coupling of a coating film transfer tool with an article of stationery according to the invention;

FIG. 2(a) is a schematic view showing a coupling structure according to the invention;

FIG. 2(b) is a schematic view showing an alternative coupling structure according to the invention, similar to the coupling structure of FIG. 2(a);

FIG. 3 is an exploded perspective view of another embodiment of a coupling structure according to the invention;

FIG. 4 is an exploded cross-sectional side view of another coupling structure according to the invention;

FIG. 5 is a front elevational view of the bore-shaped member of the coupling structure of FIG. 4;

FIG. 6 is an exploded perspective view of still another embodiment of a coupling structure according to the invention;

FIGS. 7(a) and 7(b) are front elevational views showing two alternative versions of still another embodiment of a coupling structure in accordance with the invention;

FIG. 8 is a perspective view of still another embodiment of a coupling structure according to the invention;

FIG. 9 is a schematic sectional view of a conventional coating film transfer tool coupled integral with an article of stationery;

FIG. 10 is an elevational view of another conventional coating film transfer tool coupled with an article of stationery;

FIG. 11 is a schematic sectional view of a further conventional coating film transfer tool coupled with an article of stationery;

FIG. 12 is an exploded schematic view, partly in section, of a device similar to that of FIG. 11, wherein screw threads are provided to connect the respective parts; and

FIG. 13 is an exploded schematic view, partly in section, of another device similar to that of FIG. 11, wherein projections and recesses are provided to connect the respective parts.

### DETAILED DESCRIPTION OF THE PREFERRED EMBODIMENTS

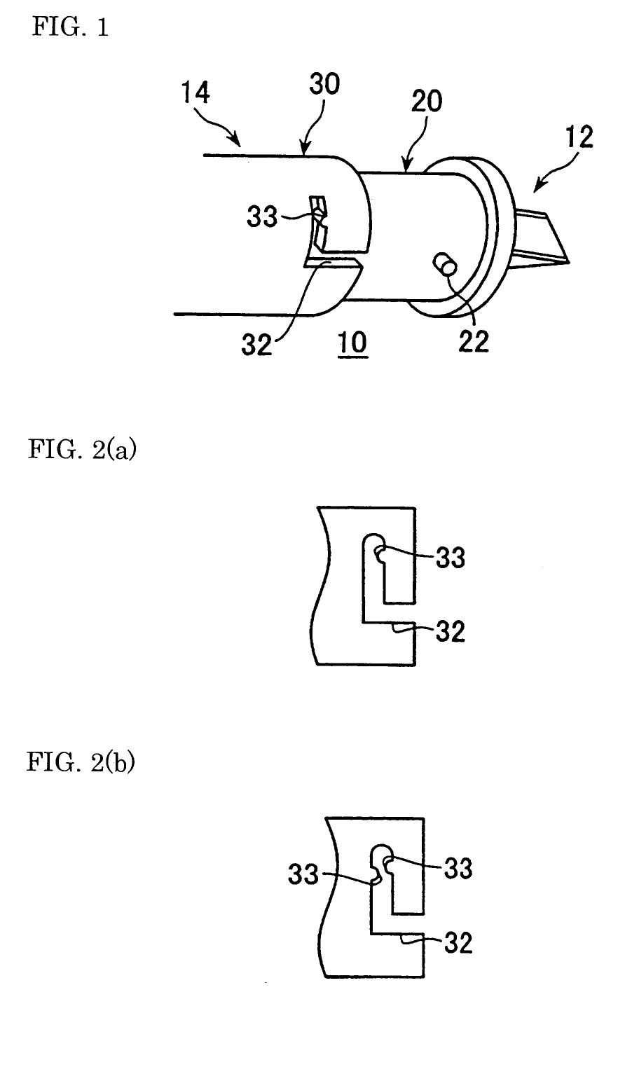

A first embodiment of a structure according to the invention, for coupling a coating film transfer tool with an article of stationery, will be described with reference to FIGS. 1-3. As shown in FIG. 1, a coupling structure 10 connects a coating film transfer tool 12 to an article of stationery 14 by a pair of cooperating installation members. One of the members is shaft-shaped member 20, formed as an integral part on an end of the coating film transfer tool 12. The other is a bore-shaped member 30, formed as an integral part on an end of the article of stationery 14. A projection 22 is formed on the shaft-shaped member 20, and a L-shaped cut-out section 32, into which the projection 22 can be inserted, is provided on the side wall of the bore-shaped member 30. The L-shaped cut-out has an entry leg extending from the opening of the bore in the direction in which the shaft-like member is moved as it is pushed into the bore, and leg extending in the circumferential direction from the inner end of the entry leg.

A stop 33, for retaining the projection 22, is provided adjacent the innermost end of the cut-out section 32, i.e., adjacent the end of the circumferential leg of the L-shaped cut-out remote from the entry leg.

The coating film transfer tool 12 can be connected in fixed relationship to the article of stationery 14 by inserting the projection 22 through the cut-out section 32, until the projection reaches the end of the entry leg of the L-shaped cut-out section, and then rotating the transfer tool 12 circumferentially until the projection 22 passes over the stop 33. The wall of the bore-shaped member has sufficient resilience that the stop will yield, allowing the projection 22 to pass toward the innermost end of the L-shaped cut-out even though the width of the projection is nearly equal to the width of the cut-out, and greater than the distance between the stop and the opposed edge of the cut-out. Likewise, the stop will yield, allowing the projection 22 to pass when the transfer tool is rotated in the opposite direction for removal.

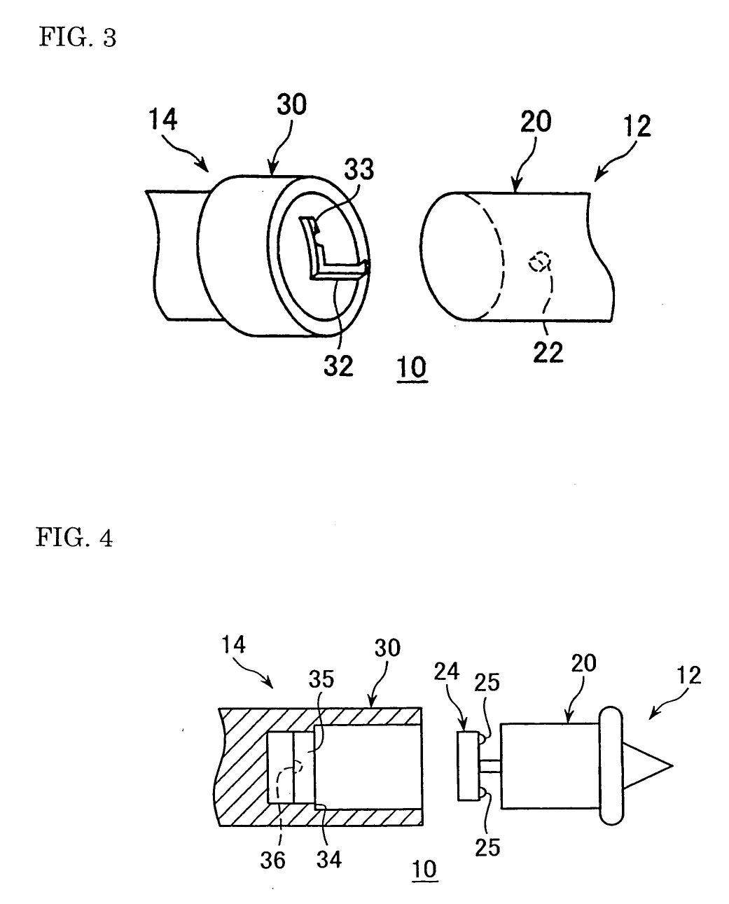

The stop 33 can be provided on only one side of the cut-out section 32 as shown in FIG. 2(a), or stops can be provided on both sides of the cut-out section 32 as shown in FIG. 2(b). The cut-out section 32 can be cut through to the outer circumferential surface of member 30 as shown in FIG. 1, or, alternatively, it can comprise a groove formed in the internal circumferential surface of member 30, as shown in FIG. 3.

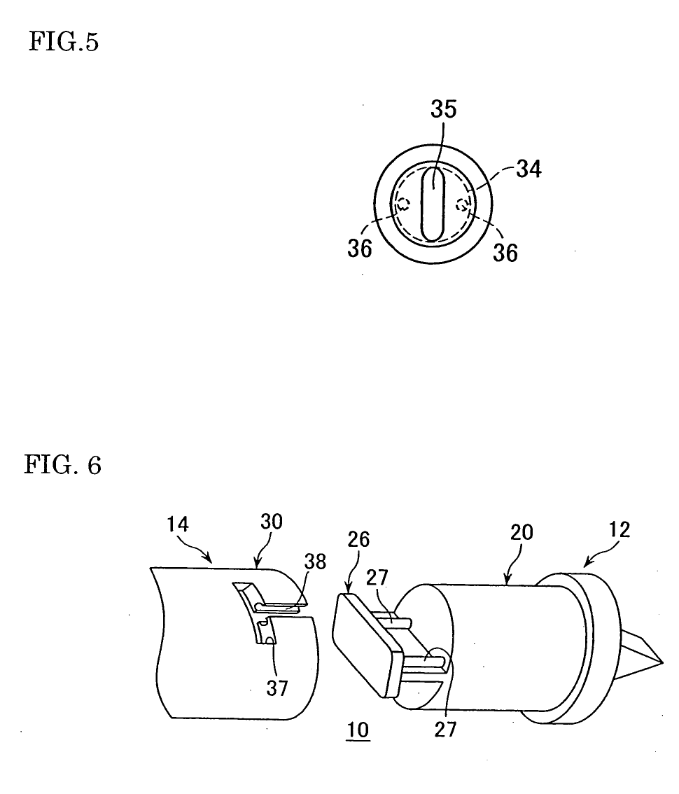

In the embodiment shown in FIGS. 4 and 5, the coupling structure comprises a shaft-shaped member 20 formed as an integral part on an end of a coating film transfer tool 12, and a bore-shaped member 30 formed as an integral part, on an end of the article of stationery 14. A partition 34 divides the bore of member 30 into two parts, and has a non-circular insertion hole 35. The shaft-shaped member 20 has an extension 24, which is connected to the main part of the shaft-shaped member by a narrow connecting member.

The extension is shaped so that it can extend through the insertion hole, but so that, when the shaft-shaped member is rotated, one or more parts of the extension move behind the partition. The insertion hole 35 may be, for example, and elongated opening having rounded ends, as shown in FIG. 5, and the extension 24 can have a corresponding shape. Recesses 36, and cooperating projections 25, are provided on the partition 34 and the extension 24 respectively. By inserting the extension 24 through the hole 35 and rotating the transfer tool 12, the projections 25 may be fitted into the recesses 36 to connect the shaft-shaped member 20 to the bore-shaped member 30. The axial length of that part of the bore which is behind the partition 34 is almost equal to the axial length of the extension 24; and therefore, the extension 24 is tightly held between the bottom of the bore and the partition 34 in the state where the projections 25 are fitted into the recesses 36; and thus, the movement of the extension 24 in the axial direction can be prevented.

As an alternative to the structure depicted in FIGS. 4 and 5, projections can be provided on the partition 34, and recesses can be provided on the extension 24. Moreover, the shapes of the insertion hole 35 and the projection 24 are not limited to the shapes shown in FIG. 5, but other shapes such as a rectangle, an ellipse, and a rhombus can be chosen.

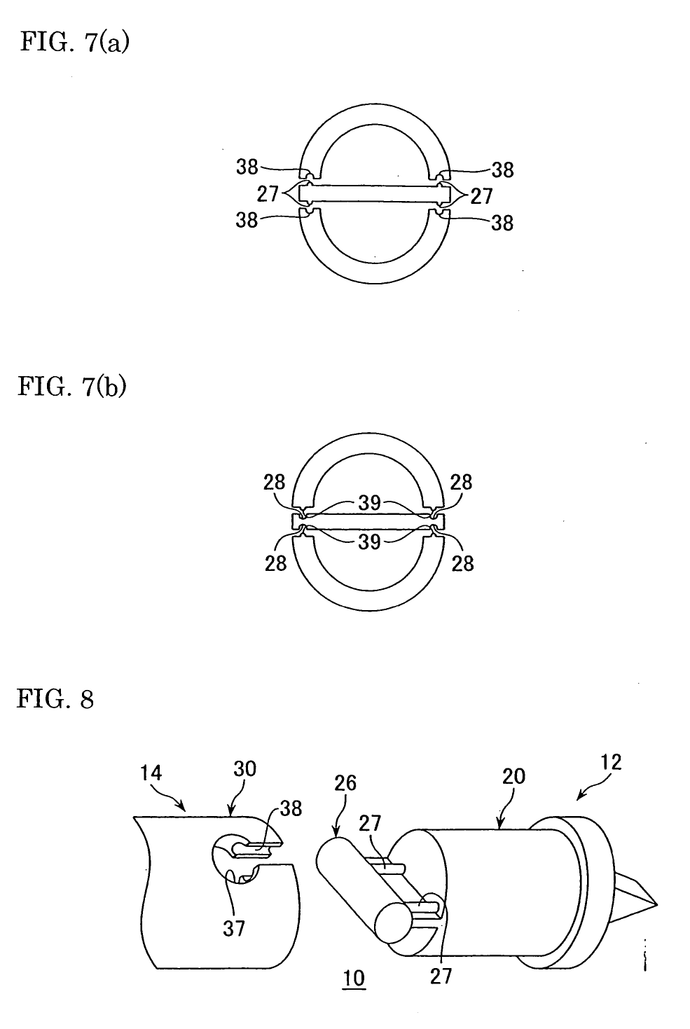

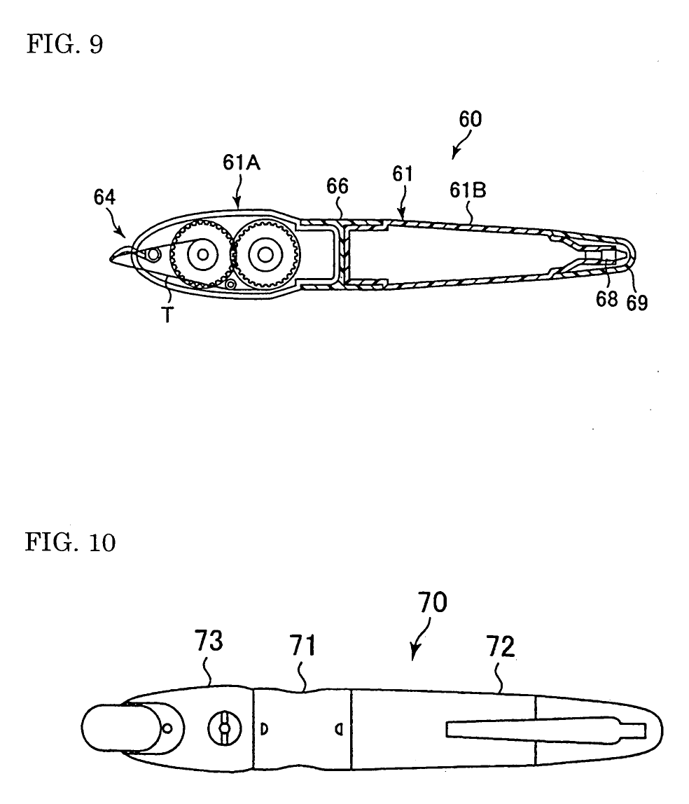

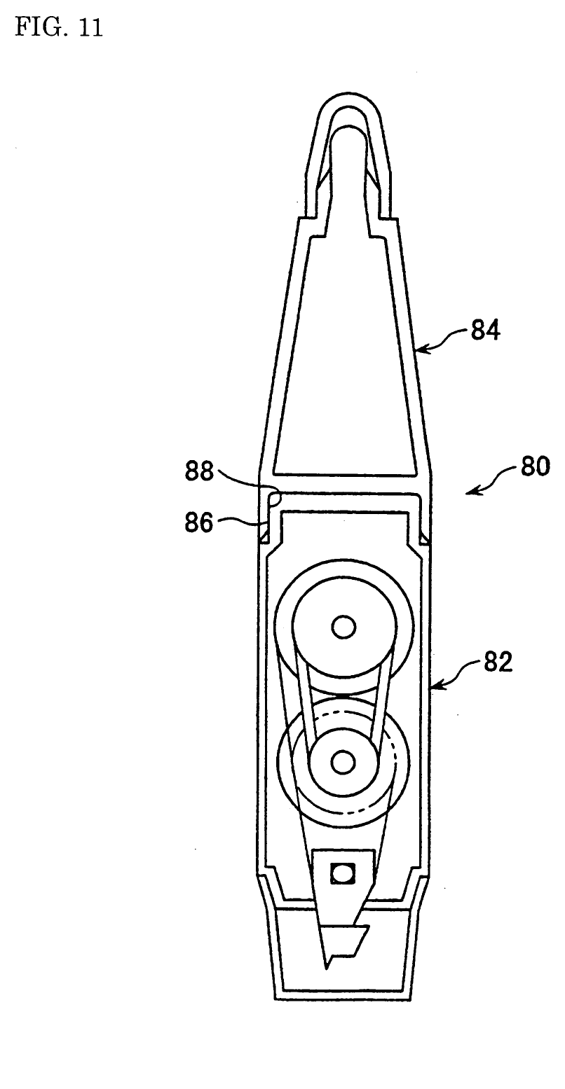

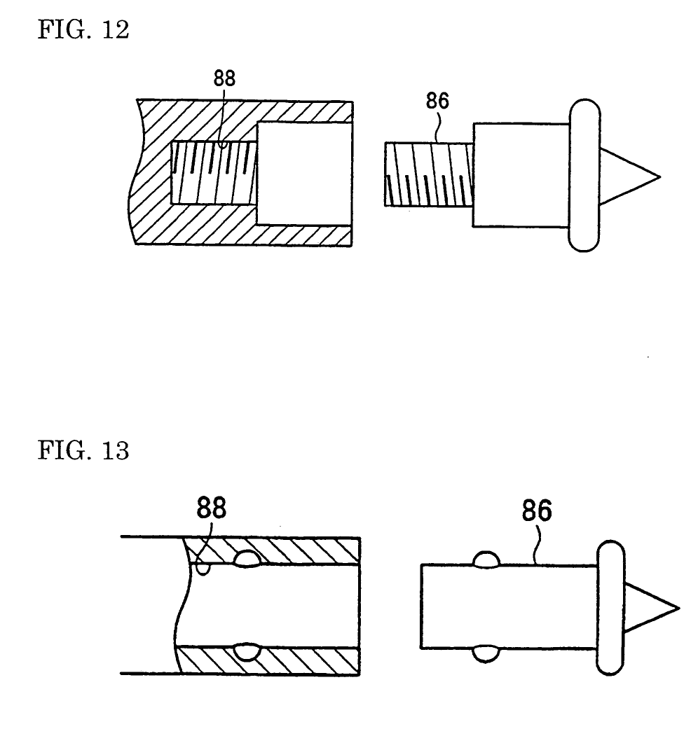

In another coupling structure, depicted in FIGS. 6-8, a shaft-shaped member 20 formed as an integral part on an end of a coating film transfer tool 12 and a bore-shaped member 30 formed as an integral part on an end of an article of stationery 14. The shaft-shaped member 20 has an elongated extension 26, which extends perpendicularly transverse to the direction in which the shaft and bore-shaped members are moved relative to each other as the shaft-shaped member enters the bore of the bore-shaped member. The extension has a uniform cross section in the direction of its elongation. A cut-out section 37, corresponding in shape to the cross-section of the extension 26, is provided in the side wall of the bore-shaped member 30. Projections 27 and recesses 38 are provided on the extension 26 and in the cut-out section 37, respectively. When the projection 26 is laterally inserted into the cut-out section 37, as shown in FIG. 7(a), the projection 27 fits into the recess 38, and the shaft-shaped member 20 can be fixed into the bore-shaped member 30.

Although a coupling structure wherein the projections 27 are provided on the projection 26 and the recesses 38 are provided in the cut-out section 37, is shown in FIG. 6 and FIG. 7(a), the invention is not limited to this arrangement, and, as an alternative, as shown in FIG. 7 (b), recesses 28 can be provided on the projection 26 and projections 39 can be provided on the cut-out section 37. Moreover, the cross section of the projection 26 is not limited to a rectangle shown in FIG. 6 but also can be in any of various other shapes, for example a circular shape as shown in FIG. 8.

In the embodiments described, the shaft-shaped member is provided on the coating film transfer tool and the bore-shaped member is provided on the article of stationery. This relationship, however, can be reversed, and a bore-shaped member can be provided on the coating film transfer tool and a shaft-shaped member can be provided on the article of stationery. In addition, the article of stationery is not limited to a writing implement such as a ballpoint pen, but can be another article of stationery such as a glue stick, an eraser, or a seal.

As explained above, according to the invention, since coupling of the transfer tool and article of stationery can be achieved by utilizing the shapes of members, fluctuations in the load at the time of insertion, and the force required to release the connected members, can be kept small, and are not greatly affected by dimensional changes in the members. Close control of the dimensions of the members is not required, and consequently, a combination coating film transfer tool and article of stationery can be produced quickly and at a lower cost. Moreover, since connection and disconnection of the members is achieved by without the use of a screw mechanism, attachment and removal of the transfer tool from the article of stationery can be achieved easily.

1. A combination coating film transfer tool and article of stationery comprising a first member formed as an integral part on one end of said coating film transfer tool and a second member formed as an integral part on one end of said article of stationery, wherein one of said members is in the shape of a shaft and the other of said members is in the shape of a bore, said member in the shape of a shaft is received in said member in the shape of a bore, a projection is formed on said shaft-shaped member, an L-shaped cut-out into which the projection can be inserted is provided in said bore-shaped member, and a stop for retaining said projection is provided adjacent the innermost end of said cut-out.

2. A combination coating film transfer tool and article of stationery comprising a first member formed as an integral part on one end of said coating film transfer tool and a second member formed as an integral part on one end of said article of stationery, wherein one of said members is in the shape of a shaft and the other of said members is in the shape of a bore, said member in the shape of a shaft is received in said member in the shape of a bore, a partition divides the bore of said bore-shaped member into two parts, said partition has an insertion hole, said shaft-shaped member has an extension corresponding in shape to said insertion hole and insertable through said insertion hole, one of said partition and said extension has a projection, and the other of said partition and said extension has a recess capable of receiving said projection, whereby, when the extension is inserted through the insertion hole in the partition and rotated, said projection may be inserted into said recess, thereby removably securing the coating film transfer tool to the article of stationery.

3. A combination coating film transfer tool and article of stationery comprising a first member formed as an integral part on one end of said coating film transfer tool and a second member formed as an integral part on one end of said article of stationery, wherein one of said members is in the shape of a shaft and the other of said members is in the shape of a bore, said member in the shape of a shaft is received in said member in the shape of a bore, said shaft-shaped member has an extension which has a uniform cross-sectional shape, said bore-shaped member has a cut-out section corresponding to the shape of said extension on its sidewall, a recess is provided on one of said extension and said cut-out section and a projection is provided on the other of said cut-out section and said extension; and said shaft-shaped member is secured to said bore-shaped member by insertion of said extension through said cut-out section, and fitting said projection into said recess.
